(19) United States
(12) Patent Application Publication
(10) Pub. No.: US 2012/0019521 A1
(43) Pub. Date: Jan. 26, 2012

(54) IMAGE OUTPUT CONTROL APPARATUS AND IMAGE OUTPUT CONTOL METHOD

(75) Inventor: Joji Yamashita, Fukaya-shi (JP)

(73) Assignee: KABUSHIKI KAISHA TOSHIBA, Tokyo (JP)

(21) Appl. No.: 13/169,760

(22) Filed: Jun. 27, 2011

(30) Foreign Application Priority Data
Jul. 22, 2010 (JP) 2010-165285

(51) Int. Cl. G06T 15/00

(52) U.S. Cl. 345/419

(57) ABSTRACT

According to one embodiment, an image output control apparatus includes a memory, an input module, and a controller. The memory is configured to store first identification information used to limit output of a 3D image. The input module is configured to input second identification information used to cancel limitation of output of the 3D image. The controller is configured to determine whether or not the second identification information is valid based on the first and second identification information to execute control to limit the output of the 3D image or cancel the output limitation based on a result of the determination.

### CROSS-REFERENCE TO RELATED APPLICATIONS

This application is based upon and claims the benefit of priority from Japanese Patent Application No. 2010-165285, filed Jul. 22, 2010; the entire contents of which are incorporated herein by reference.

### FIELD

Embodiments described herein relate generally to an image output control apparatus and an image output control method for controlling output of images.

### BACKGROUND

Various techniques for displaying three-dimensional (3D) images have hitherto been disclosed and put to practical use. However, 3D televisions have not become so common because 3D images have lower brightness and resolution than two-dimensonal (2D) images.

However, in recent years, large-capacity optical disks such as Blu-ray Disks (BDs) (registered trademark) and full-HD televisions have prevailed to enable high-quality 3D images to be reproduced in a frame sequential manner or the like. Thus, 3D televisions are expected to grow dramatically popular in the future.

Compared with 2D images, 3D images are known to fatigue viewers' eyes. Furthermore, 3D images are known to be likely to affect development of children's visual function.

However, techniques for preventing these adverse effects of 3D images are insufficient.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of the configuration of a digital television broadcast receiving apparatus (image output apparatus) according to a first embodiment to a third embodiment;

FIG. 2 is a flowchart illustrating an example of a process of setting limitation of output of 3D images (setting a registered PIN used to limit the output of 3D images);

FIG. 3 is a flowchart illustrating an example of the limitation of output of 3D images;

FIG. 4 is a diagram showing a first example of a setting menu screen;

FIG. 5 is a diagram showing an example of a 3D image output setting screen;

FIG. 6 is a diagram showing an example of a cancellation PIN input screen;

FIG. 7 is a diagram showing a second example of a 3D image output setting screen; and

FIG. 8 is a diagram showing a third example of a 3D image output setting screen.

### DETAILED DESCRIPTION

Various embodiments will be described hereinafter with reference to the accompanying drawings.

In general, according to one embodiment, an image output control apparatus includes a memory, an input module, and a controller. The memory is configured to store first identification information used to limit output of a 3D image. The input module is configured to input second identification information used to cancel limitation of output of the 3D image. The controller is configured to determine whether or not the second identification information is valid based on the first and second identification information to execute control to limit the output of the 3D image or cancel the output limitation based on a result of the determination.

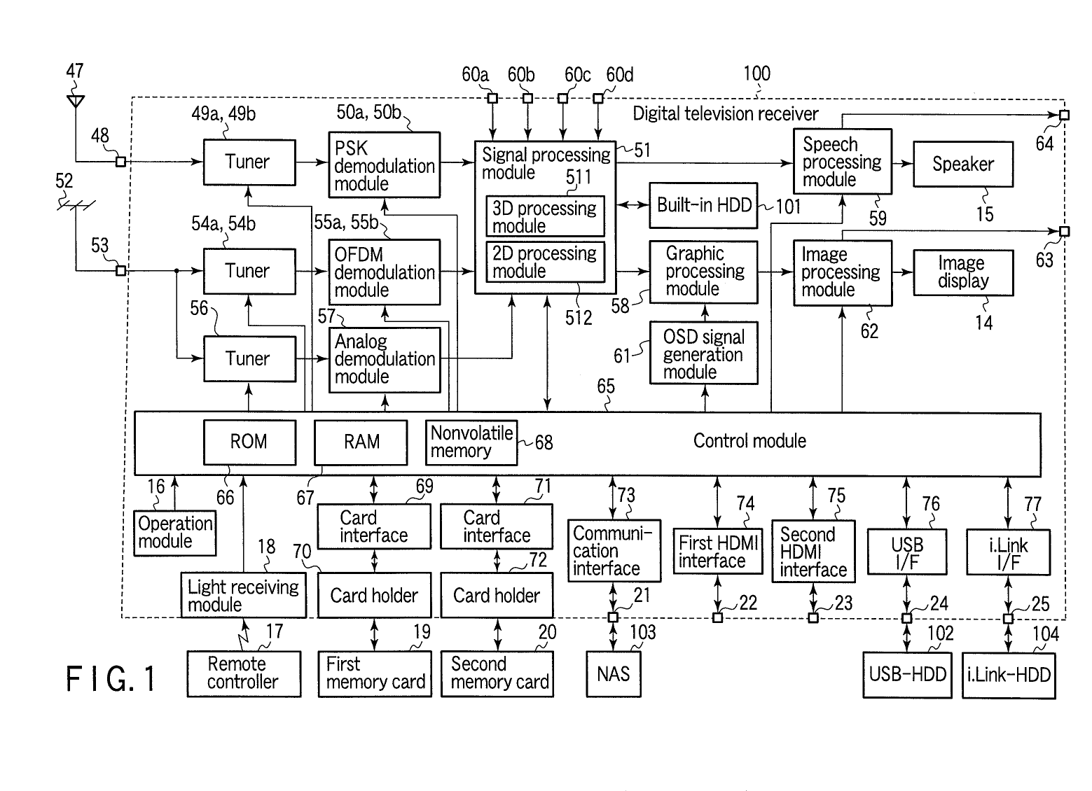

FIG. 1 is a digital television receiving apparatus (image output apparatus) according to the first to third embodiments. In the first to third embodiments, image output (control) performed by the digital television broadcast receiving apparatus is described. However, the present invention is not limited to the image output (control) performed by the digital television broadcast receiving apparatus. The image output (control) described below can be implemented by any program recording apparatus, for example, an HDD recorder, a Blu-ray Disk (BD) (registered trademark) recorder, or a DVD recorder.

With reference to FIG. 1, a digital television broadcast receiving apparatus 100 will be described. As shown in FIG. 1, a satellite digital television broadcasting signal received by an antenna 47 for reception of BS/CS digital broadcasting is supplied to satellite digital broadcasting tuners 49a and 49b via an input terminal 48. The tuners 49a and 49b select the broadcasting signal of a specified channel. The satellite digital broadcasting tuners 49a and 49b provided in the digital television broadcast receiving apparatus 100 allow satellite digital broadcasting signals of up to two channels to be simultaneously selected. As shown in FIG. 1, in a case described below, the digital television broadcast receiving apparatus 100 comprises the two satellite digital broadcasting tuners. However, the digital television broadcast receiving apparatus 100 may comprise three or more satellite digital broadcasting tuners.

The broadcasting signal selected by the tuners 49a and 49b is supplied to phase-shift keying (PSK) demodulation modules 50a and 50b. The PSK demodulation modules 50a and 50b demodulate the broadcasting signal and then output the demodulated signal to a signal processing module 51.

Furthermore, a terrestrial digital television broadcasting signal received by an antenna 52 for reception of terrestrial broadcasting is supplied to terrestrial digital broadcasting tuners 54a and 54b via an input terminal 53. The tuners 54a and 54b select the broadcasting signal of a specified channel. The terrestrial digital broadcasting tuners 54a and 54b provided in the digital television broadcast receiving apparatus 100 allow terrestrial digital broadcasting signals of up to two channels to be simultaneously selected. As shown in FIG. 1, in the case described below, the digital television broadcast receiving apparatus 100 comprises the two terrestrial digital broadcasting tuners. However, the digital television broadcast receiving apparatus 100 may comprise three or more terrestrial digital broadcasting tuners.

The broadcasting signal selected by the tuners 54a and 54b is supplied to an orthogonal frequency division multiplexing (OFDM) demodulation module 55. The OFDM demodulation module 55 demodulates the broadcasting signal into a digital image signal and a digital speech signal and outputs the image and speech signals to the signal processing module 51.

Furthermore, a terrestrial analog television broadcasting signal received by the antenna 52 for reception of terrestrial broadcasting is supplied to a terrestrial analog broadcasting tuner 56 via the input terminal 53. The tuner 56 selects the broadcasting signal of a specified channel. The broadcasting signal selected by the tuner 56 is supplied to an analog demodulation module 57. The analog demodulation module 57 demodulates the broadcasting signal into an analog image signal and an analog speech signal and outputs the image and speech signals to the signal processing module 51.

Here, the signal processing module 51 selectively carries out predetermined digital signal processing on the digital image and speech signals supplied by each of the PSK demodulation module 50 and OFDM demodulation module 55. The signal processing module 51 then outputs the processed image and speech signals to a graphic processing module 58 and a speech processing module 59.

Furthermore, a plurality of (in the illustrated apparatus, four) input terminals 60a, 60b, 60c, and 60d are connected to the signal processing module 51. Each of the input terminals 60a to 60d enables analog image and speech signals from an external source to be input to the digital television broadcast receiving apparatus 100.

The signal processing module 51 selectively digitalizes the analog image and speech signals fed from the analog demodulation module 57 and the input terminals 60a to 60d. The signal processing module 51 then carries out predetermined signal processing on the digitalized image and speech signals. The signal processing module 51 then outputs the processed signals to the graphic processing module 58 and the speech processing module 59.

The graphic processing module 58 provides a function to superimpose an OSD signal generated by an on-screen display (OSD) signal generation module 61 on the digital image signal supplied by the signal processing module 51 and then output the resultant signal. The graphic processing module 58 can selectively output the image signal output by the signal processing module 51 and the OSD signal output by the OSD signal generation module 61 or can combine the output image signal with the output OSD signal for output.

The digital image signal output by the graphic processing module 58 is supplied to an image processing module 62. The image signal processed by the image processing module 62 is supplied to an image display 14 and to an output terminal 63. The image display 14 displays an image based on the image signal. When an external apparatus is connected to the output terminal 63, an image signal supplied to the output terminal is input to the external apparatus.

Furthermore, the speech processing module 59 converts the input digital speech signal into an analog speech signal that can be reproduced by the speaker 15. The speech processing module 59 outputs the analog speech signal to the speaker 15 for speech output and also allows the analog speech signal to be transmitted to an external apparatus via an output terminal 64.

A control module 65 of the digital television broadcast receiving apparatus 100 integrally controls all processes and operations including the above-described signal processing. The control module 65 comprises a central processing unit (CPU). Based on operation information from an operation section 16 or operation information transmitted by the remote controller 17 and received via a light receiving section, the control module 65 controls the other modules so as to reflect the contents of the operation in processes carried out by the other modules.

In this case, the control module 65 mainly utilizes a read-only memory (ROM) 66 in which control programs executed by the CPU, random access memory (RAM) 67 configured to provide a work area for the CPU, and a nonvolatile memory 68 in which various pieces of setting information, control information, and the like are stored.

Furthermore, the control module 65 is connected, via a card interface 69, to a card holder 70 in which a first memory card 19 can be installed. Thus, the control module 65 can transmit information via the first memory card 19 installed in the card holder 70 and via the card interface 69.

Additionally, the control module 65 is connected, via a card interface 71, to a card holder 72 in which a second memory card 20 can be installed. Thus, the control module 65 can transmit information via the second memory card 20 installed in the card holder 72 and via the card interface 71.

In addition, the control module 65 is connected to a LAN terminal 21 via a communication interface 73. Thus, the control module 65 can transmit information, via a communication interface 73, to a LAN-compatible apparatus connected to the LAN terminal 21. In this case, the control module 65 provides a Dynamic Host Configuration Protocol (DHCP) server function to control the LAN-compatible apparatus connected to the LAN terminal 21 by assigning an Internet Protocol (IP) address to the LAN-compatible apparatus. An example of the LAN-compatible apparatus is network-attached storage (NAS) 103.

Moreover, the control module 65 is connected to a first HDMI terminal 22 via a first HDMI interface 74. Thus, the control module 65 can transmit information, via the first HDMI interface 74, to an

HDMI-compatible apparatus connected to the first HDMI terminal 22. Furthermore, the control module 65 is connected to a second HDMI terminal 23 via a second HDMI interface 75. Thus, the control module 65 can transmit information, via the second HDMI interface 75, to an HDMI-compatible apparatus connected to the second HDMI terminal 23.

The control module 65 is connected to the USB terminal 24 via a USB interface 76. Thus, the control module 65 can transmit information, via the USB interface 76, a USB-compatible apparatus connected to the USB terminal 24. An example of the USB-compatible apparatus is a USB-HDD 102.

Moreover, the control module 65 is connected to an i.Link terminal 25 via an i.Link interface 77. Thus, the control module 65 can transmit information, via the i.Link interface 77, an i.Link-compatible apparatus connected to the i.Link terminal 25. An example of the i.Link-compatible apparatus is an i.Link-HDD 104.

Furthermore, the control module 65 references programmed recording information contained in a programmed recording list stored in a nonvolatile memory 68 to control programmed recording operations. Programs are recorded in, for example, a built-in HDD 101, USB-HDD 102, NAS 103, and i.LINK-HDD 104.

Subsequently, 3D and 2D image outputs from the digital television broadcast receiving apparatus 100 will be described.

The signal processing module 51 of the digital television broadcast receiving apparatus 100 comprises a 3D processing module 511. The digital television broadcast receiving apparatus 100 is configured to be able to provide 3D images via a 3D processing module 511.

For example, the digital television broadcast receiving apparatus 100 displays 3D images using a time division system. The time division system allows 3D images to be displayed or viewed using a combination of a high-speed driving display and a pair of active liquid crystal shutter eyeglasses.

That is, the digital television broadcast receiving apparatus 100 can display 3D images corresponding to the time division system. That is, the 3D processing module 511 switches, for each frame, between a right-eye image and a left-eye image both contained in a 3D image signal, and then outputs the resultant image. In response, the image display 14 (high-speed driving display) switches the right-eye image and the left-eye image for each frame and then displays the resultant image.

A user can view 3D images with a pair of active liquid crystal shutter glasses. That is, the pair of liquid crystal shutter glasses alternately closes a right-eye shutter and a left-eye shutter in response to the switching between the right-eye image and the left-eye image for each frame. Thus, the right eye views the right-eye image, whereas the left eye views the left-eye image.

An example of 3D image display based on the time division system has been described above. However, other 3D display systems are also applicable. For example, a 3D image display system allowing the user to view 3D images with the naked eye can also be applied.

Furthermore, the 3D processing module 511 carries out a 3D conversion process of converting a 2D image signal into a 3D image signal to provide a 3D image based on the 2D image signal.

Moreover, the signal processing module 51 of the digital television broadcast receiving apparatus 100 comprises a 2D processing module 512. The digital television broadcast receiving apparatus 100 is configured to be able to provide 2D images via a 2D processing module 512. For example, the 2D processing module 512 carries out a 2D conversion process of converting a 3D image signal into a 2D image signal to provide 2D images based on the 3D image signal.

As described above, the digital television broadcast receiving apparatus 100 can provide 3D images based on a 3D image signal, provide 2D images based on a 3D image signal, provide 2D images based on a 3D image signal, and provide 2D images based on a 2D image signal.

A 2D conversion process and a 3D conversion process disclosed in, for example, Jpn. Pat. Appln. KOKAI Publication No. 2006-121553 can be applied to the 3D conversion process in the 3D processing module 511 and the 2D conversion process in the 2D processing module 512, respectively.

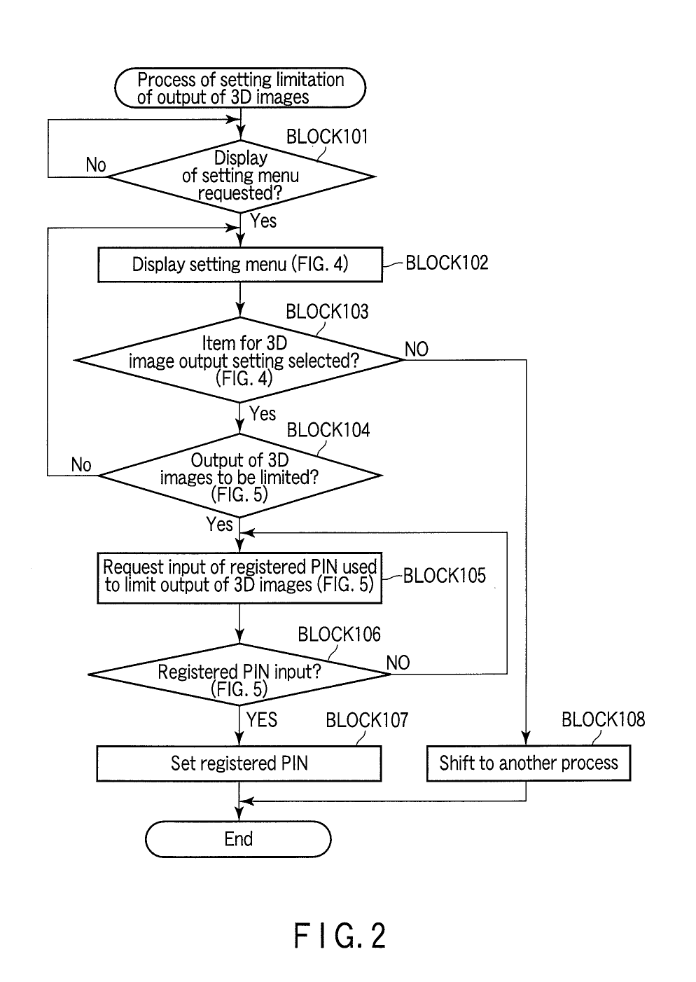

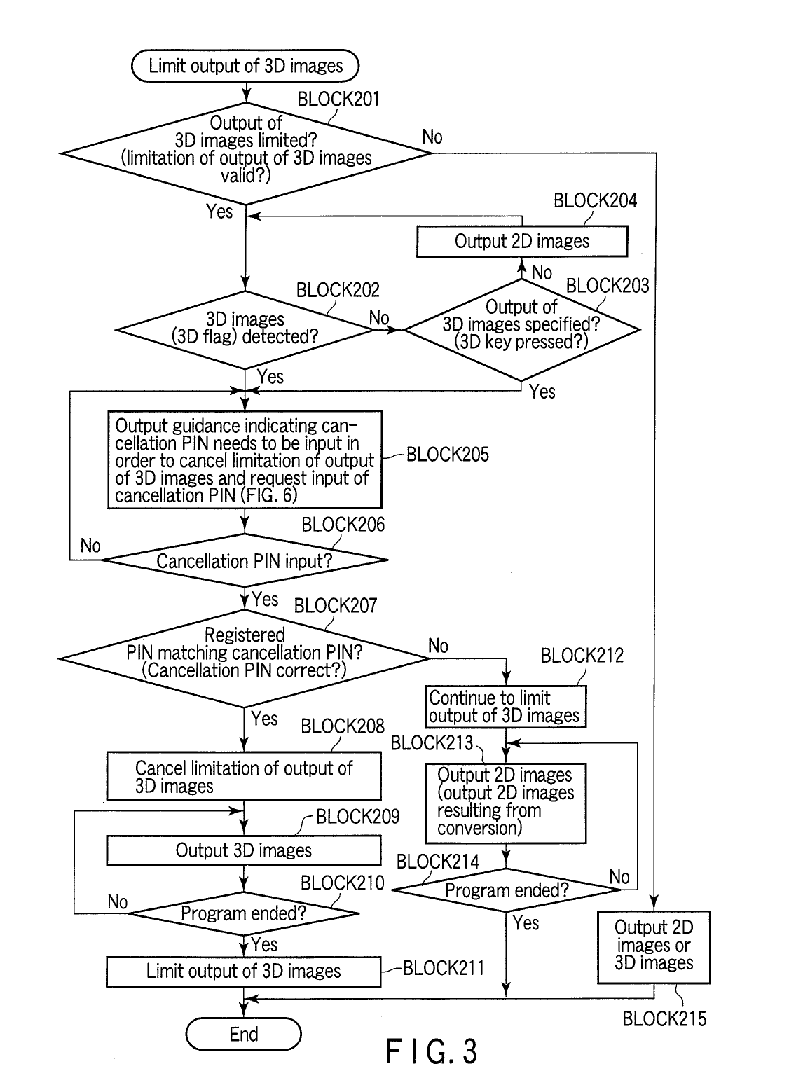

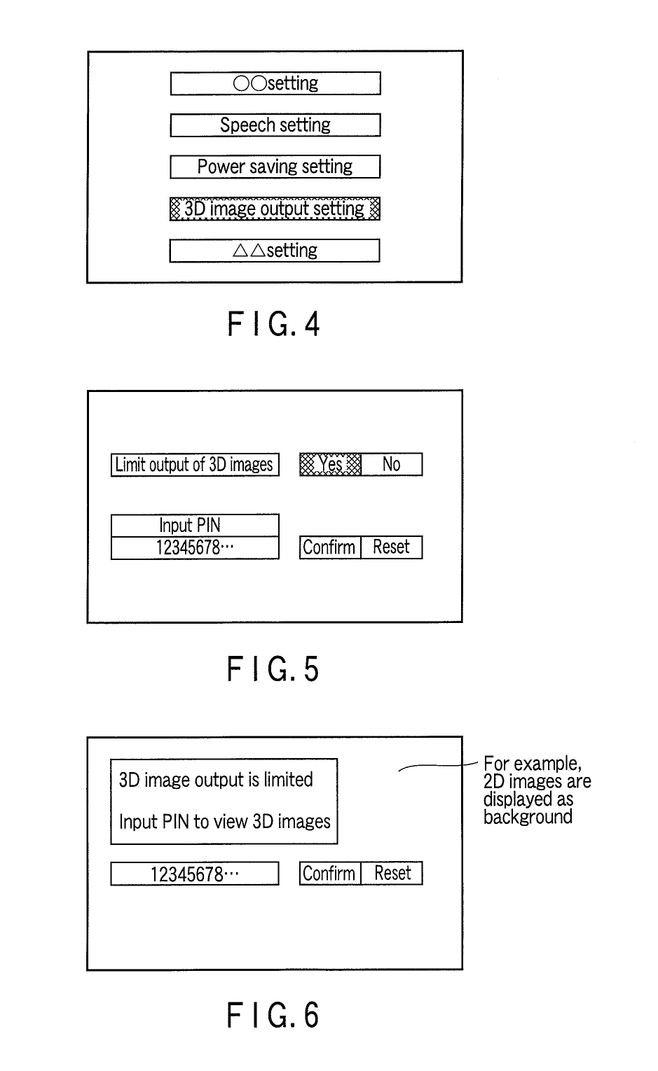

Now, with reference to the flowcharts shown in FIG. 2 and FIG. 3 and the examples of screens shown in FIG. 4 to FIG. 8, an example of image output control performed by the digital television broadcast receiving apparatus will be described.

### First Embodiment

The nonvolatile memory 68 of the digital television broadcast receiving apparatus 100 is configured to store first identification information (personal identification number [PIN]) used to limit the output of 3D images. The control module 65 of the digital television broadcast receiving apparatus 100 requests input of second identification information (personal identification number [PIN]) used to cancel the limitation of output of 3D images. Based on the stored first information (hereinafter referred to as the registered PIN) and the input second identification information (hereinafter referred to as the cancellation PIN), the control module 65 determines whether or not the cancellation PIN is valid. The control module 65 executes control to limit the output of 3D images or cancel the limitation of the output based on the result of the determination.

For example, the control module 65 compares the registered PIN with the cancellation PIN. Then, based on the determination of invalidity of the cancellation PIN resulting from the mismatch between the registered PIN and the cancellation PIN, the control module 65 executes control to reject the output of 3D images. Based on the determination of validity of the cancellation PIN resulting from the match between the registered PIN and the cancellation PIN, the control module 65 executes control to output 3D images.

For example, if the user specifies a predetermined channel (3D image program) via the remote controller 17 or the like, the tuner 54a and the like selects one of the broadcasting signals which belongs to the predetermined channel. However, when the cancellation PIN is incorrectly input, the control module 65 executes control to prevent 3D images corresponding to the signal of the predetermined channel from being output. When the cancellation PIN is correctly input, the control module 65 executes control to output the 3D images corresponding to the signal of the predetermined channel.

The control of output 3D images based on the registered PIN and the cancellation PIN will be described below in detail.

First, with reference to FIG. 2, an example of a process of setting limitation of the output of 3D images (setting a registered PIN used to limit the output of 3D images) will be described.

The user can instruct the apparatus to display a setting menu, for example, via a setting menu key provided on the remote controller 17. The remote controller 17 requests display of the setting menu in response to pressing of the setting menu key (BLOCK 101, YES). The control module 65 receives the request for the display of the setting menu via the light receiving module 18, to control the display of the setting menu. In response, the image display 14 displays such a setting menu as shown in FIG. 4 (BLOCK 102).

Subsequently, the user can select an item for 3D image output setting displayed on the setting menu, via direction keys and an Enter key provided on the remote controller 17. The remote controller 17 requests item selection for 3D image output setting in response to pressing of the direction keys and Enter key (BLOCK 103, YES). The control module 65 receives the request for the item selection for 3D image output setting via the light receiving module 18 to control the display of a 3D image output setting screen. In response, the image display 14 displays such a 3D image output setting screen as shown in FIG. 5.

For example, as shown in FIG. 5, the 3D image output setting screen displays “3D image output to be limited? YES/NO”. The user selects “YES” displayed on the 3D image output setting menu, via the direction keys and Enter key provided on the remote controller 17 (BLOCK 104, YES). Then, the control module 65 detects the selection of “YES” and requests the user to input a registered PIN used to limit the output of 3D images (BLOCK 105). For example, the request, from the control module 65, for the input of the registered PIN enables the registered PIN to be input onto the 3D image output setting screen.

The user inputs the registered PIN via the numeric keys and Enter key provided on the remote controller 17, and then selects “Confirm” (BLOCK 106, YES). Then, the control module 65 sets the registered PIN (BLOCK 107). For example, the registered PIN is stored in the nonvolatile memory 68. Even after the registered PIN is set, the 3D image output limitation can be enabled or disabled via such a 3D image output setting screen as shown in FIG. 5.

Now, with reference to FIG. 3, an example of the 3D image output limitation will be described.

With the output of 3D images limited (with the 3D image output limitation enabled) as described above (BLOCK 201, YES), the signal processing module 51 detects, in an input signal, 3D information (3D flag) indicating that the input signal contains 3D images (BLOCK 202, YES). Then, the control module 65 executes control to output a guidance indicating that the cancellation PIN needs to be input in order to cancel the limitation of output of 3D images. The control module 65 further requests the input of the cancellation PIN (BLOCK 205). In response, the image display 14 displays such a cancellation PIN input screen as shown in FIG. 6.

The 2D processing module 512 converts a 3D image signal contained in the input signal into a 2D image signal. The control module 65 executes control to output 2D images based on the 2D image signal as a background of the cancellation PIN input screen. Moreover, the 2D processing module 512 can generate a 2D image signal from a single-eye image forming the 3D image signal.

Even if the signal processing module 51 fails to detect 3D information in the input signal, the signal processing module 51 can analyze the input signal to determine whether or not the input signal contains 3D images. For example, as described above, a 3G image signal comprises a right-eye image signal and a left-eye image signal. The signal processing module 51 can detect a thus configured image signal in the input signal to determine whether or not the input signal corresponds to a 3D image signal.

In another case, with the output of 3D images limited (with the 3D image output limitation enabled) (BLOCK 201, YES), the remote controller 17 requests output of 3D images in response to pressing of a 3D key provided on the remote controller 17 (BLOCK 203, YES). Then, the controller 65 detects the request for output of 3D images, executes control to output a guidance indicating that the cancellation PIN need to be input in order to cancel the limitation of output of 3D images, and requests the input of the cancellation PIN (BLOCK 205). In response, the image display 14 displays such a cancellation PIN input screen as shown in FIG. 6. Moreover, the control module 65 may convert 3D images into 2D images and executes control to output the 2D images as a background.

If the 3D information (3D flag) is not detected (BLOCK 202, NO) and the output of 3D images is not requested (BLOCK 203, NO), then for example, the image display 14 displays 2D images (BLOCK 204).

With such a cancellation PIN input screen as shown in FIG. 6 displayed, the user inputs the cancellation PIN used to cancel the limitation of output of 3D images, via the numeric keys and Enter key provided on the remote controller 17, and then selects “Confirm” (BLOCK 206, YES). Then, the control module 65 compares the registered PIN stored in the nonvolatile memory 68 with the input cancellation PIN to determine whether or not the cancellation PIN is valid.

Based on the determination of invalidity of the cancellation PIN resulting from the mismatch between the registered PIN and the cancellation PIN, the control module 65 continues to limit the output of 3D images (BLOCK 212). If the registered PIN fails to match the cancellation PIN, the control module 65 requests reentry of the cancellation PIN.

Furthermore, based on the determination of validity of the cancellation PIN resulting from the match between the registered PIN and the cancellation PIN, the control module 65 executes control to cancel the limitation of output of 3D images (BLOCK 208). As illustrated in a cancellation process 1 or a cancellation process 2 described below, the control module 65 executes control to cancel the limitation of output of 3D images, to output 3D images (BLOCK 209), and at a predetermined timing (BLOCK 210, YES), limits the output of 3D images again (BLOCK 211).

<Cancellation Process 1>

The control module 65 continues to cancel the limitation of output of 3D images until the digital television broadcast receiving apparatus 100 is powered off. Hence, when the user selects a predetermined channel (3D image program), the digital television broadcast receiving apparatus 100 selects one of the broadcasting signals which belongs to the predetermined channel. The digital television broadcast receiving apparatus 100 then outputs 3D images corresponding to the selected signal of the predetermined channel. If the digital television broadcast receiving apparatus 100 is powered off and then on, the control module 65 limits the output of 3D images again. Thus, when the user selects a selects a predetermined channel (3D image program), the control module executes control to output a guidance indicating that the cancellation PIN needs to be input in order to cancel the limitation of output of 3D images, and requests the input of the cancellation PIN. In response, the image display 14 displays the cancellation PIN input screen.

<Cancellation Process 2>

The control module 65 continues to cancel the limitation of output of 3D images while the selected program is being output. Hence, the control module 65 outputs 3D images of the selected program (BLOCK 209). When the program ends (BLOCK 210, YES), the control module 65 limits the output of 3D images again (BLOCK 211). Thus, when the user selects a 3D image program after the end of the above-described program, the control module 65 executes control to output a guidance indicating that the cancellation PIN needs to be input in order to cancel the limitation of output of 3D images, and requests the input of the cancellation PIN. In response, the image display 14 displays the cancellation PIN input screen.

Furthermore, based on the determination of invalidity of the cancellation PIN resulting from the mismatch between the registered PIN and the cancellation PIN, the control module 65 continues to limit the output of 3D images as illustrated in an output limitation process 1 and an output limitation process 2 described below.

<Output Limitation Process 1>

The control module 65 executes control to output 2D images (BLOCK 212). For example, if the selected program is a 3D image program, the control module 65 switches to and outputs 2D images of another program (BLOCK 212).

<Output Limitation Process 2>

The control module 65 converts 3D images into 2D images and executes control to output the 2D images (BLOCK 212). For example, if the selected program is a 3D image program, the 2D processing module 512 converts 3D images of the selected program into 2D images. Then, the control module 65 executes control to output the resultant 2D images (BLOCK 212).

### Second Embodiment

In the first embodiment, the cancellation process 1 and the cancellation process 2 have been described. However, a cancellation process 3 illustrated below may be applied. That is, as illustrated in the cancellation process 3 described below, the control module 65 cancels the limitation of output of 3D images and executes control to output 3D images (BLOCK 209). Then, at a predetermined timing (BLOCK 210, YES), the control module 65 limits the output of 3D images again (BLOCK 211).

<Cancellation Process 3>

The control module 65 continues to cancel the limitation of output of 3D images during a set output permitted time. Hence, when a 3D image output time becomes equal to the output permitted time, the control module 65 stops outputting 3D images, and limits the output of 3D images.

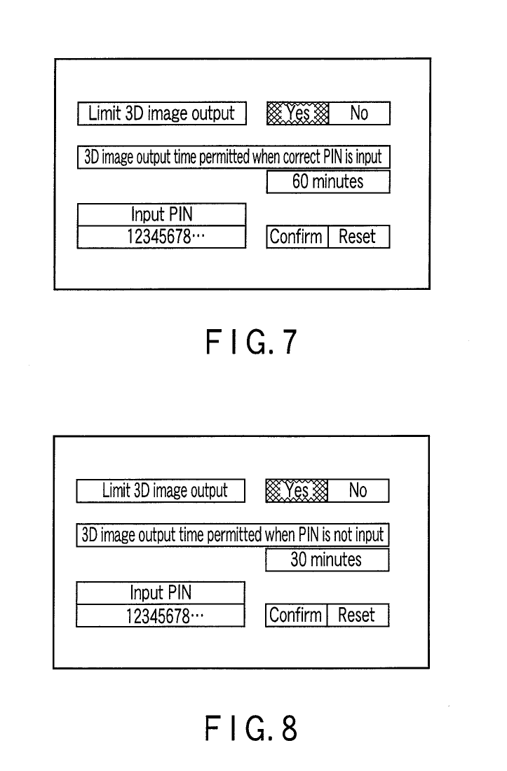

For example, the time (for example, 60 minutes) for which the output of 3D images is permitted when the correct PIN is input can be set using the remote controller 17, via such a 3D image output setting screen as shown in FIG. 7. The set output permitted time is stored in the nonvolatile memory 68.

Moreover, the control module 65 compares the 3D image output time with the output permitted time. The control module 65 then requests the input of the cancellation PIN in accordance with the result of the comparison. For example, the control module 65 requests the input of cancellation PIN when the 3D image output time becomes equal to the output permitted time or when the output permitted time expires in 5 minutes. In response, the image display 14 displays the cancellation PIN input screen.

### Third Embodiment

In the first embodiment, the output limitation process 1 and the output limitation process 2 have been described. However, an output limitation process 3 illustrated below may be applied. That is, as illustrated in the output limitation process 3 described below, the control module 65 continues to limit the output of 3D images.

<Output Limitation Process 3>

The control module 65 executes control to output 3D images during the set output permitted time. When the 3D image output time becomes equal to the output permitted time, the control module 65 executes control to stop the output of 3D images. Thereafter, the control module 65 executes the output condition 1 or the output condition 2.

The time (for example, 30 minutes) for which the output of 3D images is permitted when PIN is not input can be set using the remote controller 17, via such a 3D image output setting screen as shown in FIG. 8. The set output permitted time is stored in the nonvolatile memory 68.

As illustrated in the above-described first, second, and third embodiments, the digital television broadcast receiving apparatus 100 can set the limitation of output of 3D images before 3D images are output. Furthermore, the digital television broadcast receiving apparatus 100 can cancel the limitation of output of 3D images in response to the input of the correct cancellation PIN. Thus, children with the visual function still developing can be prevented from continuing to view 3D images without permission.

The digital television broadcast receiving apparatus 100 is configured to be able to store a V-chip PIN used to limit a permitted age for program viewing. The V-chip PIN is managed separately from the registered PIN used to limit the output of 3D images. That is, the digital television broadcast receiving apparatus 100 can carry out the limitation of the permitted age for program viewing separately from the limitation of output of 3D images.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional (3D) image output control apparatus comprising:
a memory configured to store a first identification information;
an input module configured to receive a second identification information; and
a controller configured to determine whether to output a 3D image based on whether the second identification information is valid based on the first identification information.

2. The apparatus of claim 1, wherein the controller is configured to prevent output of the 3D image if the second identification information is not valid.

3. The apparatus of claim 2, wherein the controller is configured to output a two-dimensional (2D) image if the second identification information is not valid.

4. The apparatus of claim 2, wherein the controller is configured to convert the 3D image of a selected program into a 2D image and to output the 2D image if the second identification information is not valid.

5. The apparatus of claim 2, wherein the controller is configured to output the 3D image for an output permitted time after the determination that the second identification information is valid.

6. The apparatus of claim 5, wherein the controller is further configured to output the 2D image after the output permitted time has expired.

7. The apparatus of claim 4, wherein the controller is configured to output the 3D image of the selected program based on the determination of validity.

8. The apparatus of claim 7, wherein the controller is configured to stop the output of the 3D image after the program ends.

9. The apparatus of claim 5, wherein the controller is configured to request reentry of the second identification information after the output permitted time has expired.

10. The apparatus of claim 1, further comprising:
a detector configured to detect 3D information in an input signal indicating that the input signal comprises the 3D image, and
wherein the controller is configured to request input of the second identification information based on the detector's detection of the 3D information.

11. The apparatus of claim 10, wherein the controller is configured to output guidance information and an input item based on the detector's detection of the 3D image, the guidance information indicating that output of the 3D image depends on input of the second identification information, and the input item configured to receive input of the second identification information.

12. The apparatus of claim 10, wherein the controller is further configured to:
convert the 3D image into a 2D image; and
output, based on the detector's detection, the 2D image and an input item, the input item configured to receive input of the second identification information

13. The apparatus of claim 1, wherein the controller is configured to request input of the second identification information in response to an instruction to output the 3D image.

14. The apparatus of claim 1, further comprising:
a selector configured to select a specified channel signal from a plurality of channels,
wherein the controller is configured to limit output of a 3D image corresponding to the selected specified channel signal.

15. An image output control method comprising:
determining whether a second identification information is valid based on a first identification information; and
limiting an output of a 3D image based the determination.
